(19) United States
(12) Patent Application Publication
(10) Pub. No.: US 2010/0245660 A1
(43) Pub. Date: Sep. 30, 2010

(54) Camera

(76) Inventor: Tetsuo Saitoh, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/611,812

(22) Filed: Nov. 3, 2009

(30) Foreign Application Priority Data
Mar. 24, 2009 (JP) 2009-072481

(51) Int. Cl. H04N 5/225

(52) U.S. Cl. 348/373; 348/E05.024

(57) ABSTRACT

According to one embodiment, a camera includes a camera head, an optical unit, a camera control unit (CCU), a camera head-side connector, and a CCU-side connector. The camera head has an imaging element. The CCU has an image processing circuit that processes image information acquired by the imaging element therein. The camera head-side connector is provided to protrude beyond an outer shape of the camera head. The CCU-side connector is opened in an outer wall of the CCU, and the camera head-side connector is inserted into the CCU-side connector.

### CROSS-REFERENCE TO RELATED APPLICATIONS

This application is based upon and claims the benefit of priority from Japanese Patent Application No. 2009-072481, filed Mar. 24, 2009, the entire contents of which are incorporated herein by reference.

### BACKGROUND

1. Field

One embodiment of the invention relates to a camera in which a camera head having an imaging element and a camera control unit having an imaging controller and others are separately configured.

2. Description of the Related Art

In case of a camera installed as a stationary camera for the purpose of, e.g., monitoring a production line in a factory, acquisition of an image having a high resolution is demanded. Since a camera that can acquire an image having a high resolution has a bulky external shape, a place where the camera can be installed is limited. When there is a sufficient installation space, a camera in which a head and a main body are integrally configured is adopted. When a sufficient installation space cannot be assured, a camera in which a head and a main body are separately configured is adopted.

However, it is uneconomical to simultaneously develop and produce two types of cameras, which are the camera in which the head and the main body are integrally provided and the camera in which the head and the main body are separated from each other. Therefore, it is demanded the camera which can be used in two ways, i.e., a state where the head and the main body are integrated and a state where they are separated from each other.

A specification in Japanese Patent No. 3750425 discloses a camera system configured in such a manner that a lens unit is detachable from a main body with any inhabitation. The main body includes a CPU, a program memory, an image memory, a connector, and others. The lens unit includes a COD driving unit, a COD imaging sensor, a shutter, an imaging lens, and a connector. The main body and the lens unit are coupled with each other by engaging connectors provided on respective side portions thereof.

Further, Jpn. Pat. Applin. KOKAI Publication No. JP 10-079907A discloses a digital camera in which a main body and an imaging unit are separately configured. The main body includes a jointing plate having a connector provided thereto, an image memory, and a display unit. The imaging unit has an imaging lens, a COD, and an attachment unit. This digital camera can be used by directly jointing the attachment unit of the imaging unit to the jointing plate of the main body, and it can be also used by connecting the attachment unit of the imaging unit to the connecting plate of the main body through a dedicated connection cable.

However, the camera system disclosed in the specification of Japanese Patent No. 3750425 is configured to change the lens unit in accordance with imaging conditions, and it is not designed to be used in a state where the lens unit is separated from the main body. Furthermore, since it is intended to identify whether the lens unit is a so-called genuine product, a specific connection structure of the lens unit and the main body is omitted to illustrate.

In case of the digital camera disclosed in Jpn. Pat. Applin. KOKAI Publication No. JP 10-079907, the imaging unit and the main body cannot be connected with each other unless a dedicated connection cable which has connecting portions having the same shapes as those of respective connectors formed at end portions thereof is used. Moreover, since it is intended to avoid degradation in an image due to connect with the cable, structures of the connectors are not sufficiently examined.

When the head is used by separating from the main body, a sufficient space where both the head and the main body are arranged cannot be assured. Therefore, a smaller head is preferable in order to avoid the limitation in size, when the camera separates the head from the main body.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a cross-sectional view of a camera of a first embodiment of the present invention;

FIG. 2 is a cross-sectional view of a camera head shown in FIG. 1;

FIG. 3 is an exploded perspective view in which a joint bracket is removed from the camera shown in FIG. 1;

FIG. 4 is an exploded perspective view of a state where the camera head and a camera control unit (CCU) shown in FIG. 1 are connected with each other through a cable;

FIG. 5 is an exploded perspective view of a camera of a second embodiment of the present invention;

FIG. 6 is a perspective view of a camera of a third embodiment of the present invention;

FIG. 7 is a front view of a camera head of a fourth embodiment of the present invention showing from a lens side; and

FIG. 8 is a perspective view of the camera which connect the camera head shown in FIG. 7 with a camera control unit (CCU) using one of connectors of the camera head.

### DETAILED DESCRIPTION

Various embodiments according to the invention will be described hereinafter with reference to the accompanying drawings. In general, a camera according to an embodiment of the present invention comprises a camera head, an optical unit, a camera control unit (CCU), a camera head-side connector, and a CCU-side connector. The camera head is carrying an imaging element. The optical unit projects a subject image onto the imaging element. The CCU includes an image processing circuit that processes image information acquired by the imaging element. The camera head-side connector is provided to protrude beyond an outer shape of the camera head, and outputs the image information. The CCU-side connector is opened in an outer wall of the CCU, and the camera head-side connector is inserted into this connector.

The camera is used in both a state where the camera head is integrally connected with the CCU and a state where the camera head is detached from the CCU and connected with the CCU through a cable. Since, the camera head-side connector is provided to protrude beyond the outer shape of the camera head in the camera, an area taken up by the camera head is reduced.

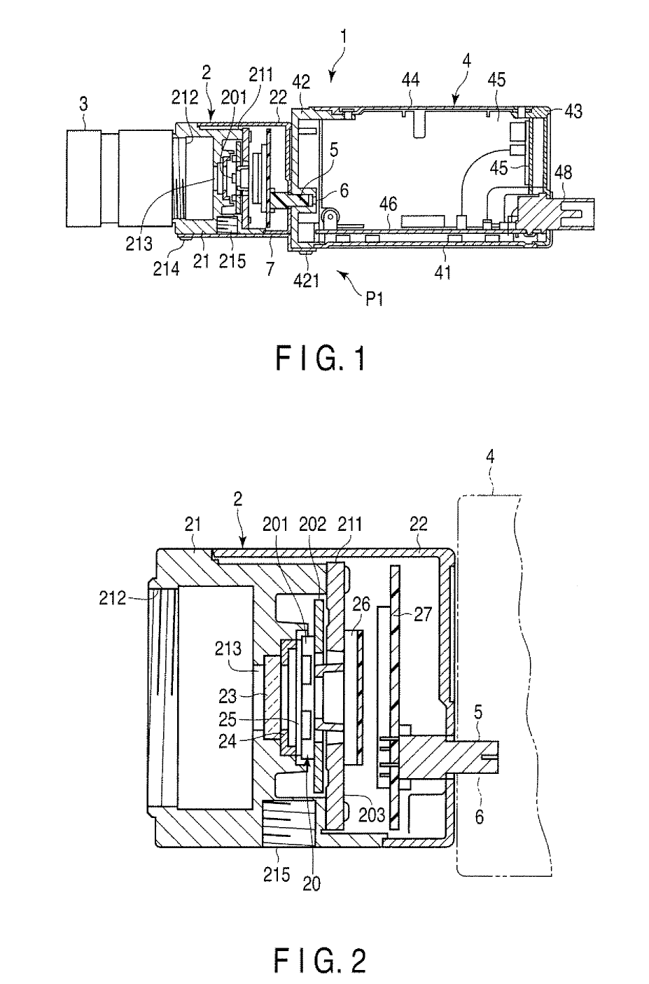

A camera 1 of a first embodiment of the present invention will now be described with reference to FIGS. 1 to 4. The camera 1 shown in FIG. 1 comprises a camera head 2, an optical unit 3, a CCU 4, a camera head-side connector 5, and a CCU-side connector 6. As shown in FIG. 2, the camera head 2 has a housing 21 and a cover 22 that form an outer shell of the camera head 2, and carries an imaging element 201. The housing 21 is formed of a cast member such as an aluminum alloy having a high rigidity. Besides the aluminum alloy, a magnesium alloy or a zinc alloy may be used.

The imaging element 201 is a complementary metal oxide silicon (CMOS) image sensor or a CCD image sensor. The imaging element 201 is fixed to a support frame 203 in a state where it is mounted on a sensor substrate 202. A sensor module 20 constituted of the imaging element 201, the sensor substrate 202, and a protection glass 25 is fixed to a module support 211 of the housing 21 through the support frame 203. The housing 21 further has a lens mount 212 and a light receiving window 213.

The lens mount 212 has a female screw that fits a male screw provided on a base portion of the optical unit 3 on an inner periphery, and holds the optical unit 3 in such a manner that an optical axis of the optical unit 3 becomes vertical to a light receiving surface of the imaging element 201. The optical unit 3 includes a lens group constituted of a plurality of lenses, and projects a subject image onto the imaging element 201. The light receiving window 213 is opened between the optical unit 3 and the imaging element 201, and functions as an aperture that blocks extra light so that an image of a subject can be formed in accordance with a shape of the light receiving surface of the imaging element 201. A filter glass 23 fitted in the light receiving window 213 is held by the sensor module 20 through a packing 24.

The sensor substrate 202 is connected to a signal processing circuit 27 through a flexible wiring 26. The camera head-side connector 5 is connected to an output of the signal processing circuit 27. The signal processing circuit 27 converts a signal acquired by the imaging element 201 into image information and outputs this information from the camera head-side connector 5. The cover 22 covers the sensor module 20, the signal processing circuit 27, and the base portion of the camera head-side connector 5 and is assembled with the housing 21. A portion of the camera head-side connector 5 that is inserted into the CCU-side connector 6 protrudes from the cover 22.

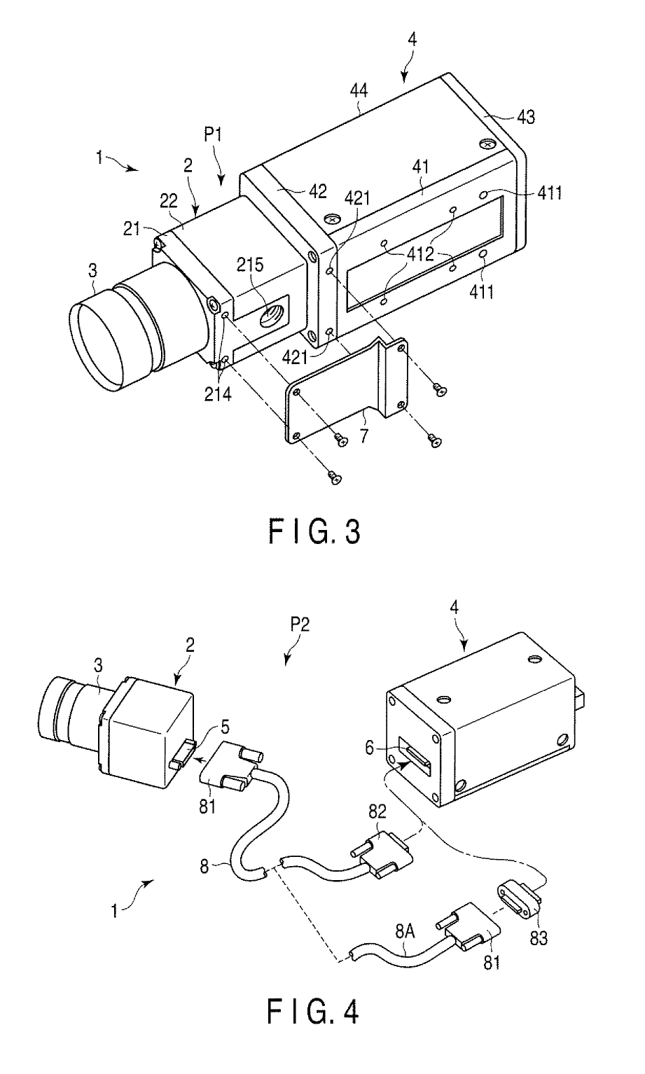

The CCU 4 has a base panel 41, a front block 42, a rear block 43, and a cover panel 44 that constitute an outer shape thereof as shown in FIGS. 1 and 3. The front block and the rear block 43 are coupled with both ends of the base panel 41. The CCU 4 as shown in FIG. 1, houses an image processing circuit 45 that processes the image information output from the camera head 2 side. The image processing circuit 45 is formed on each of a plurality of printed wiring boards 46 disposed in a space between the front block 42 and the rear block 43.

The COG-side connector 6 into which the camera head-side connector 5 is inserted is opened in an outer wall of the front block 42. The COG-side connector 6 is connected with the printed wiring board 46. A signal of the subject image acquired by the imaging element 201 is converted into the image information by the signal processing circuit 27, and then supplied to the image processing circuit 45 through the camera head-side connector 5 and the CCU-side connector 6. The signal of the subject visualized by the image processing circuit 45 is output as a picture signal through an output terminal 48 protruding beyond an outer wall of the rear block 43. The cover panel 44 covers the printed wiring boards 46 and is attached between the front block 42 and the rear block 43.

As shown in FIGS. 1 and 2, in a combined state P1 that the camera head-side connector 5 is directly inserted into and connected with the CCU-side connector 6 to integrate the camera head 2 and the CCU 4, the outer wall of the cover 22 in the camera head 2 comes into contact with the outer wall of the front block 42 in the CCU 4. To assure joint strength of the camera head 2 and the CCU 4, a fixing bracket 7 that attaches the camera head 2 with the CCU 4 is further provided in this embodiment.

The fixing bracket 7 is assembled by utilizing camera head fixing-screw holes 214 and CCU fixing-screw holes 421. Each camera head fixing-screw hole 214 is provided in an outer wail of the housing 21 at a portion that does not face the CCU 4 in a state where the camera head-side connector 5 is inserted in the CCU-side connector 6. The camera head fixing-screw holes 214 are prepared to solely fix the camera head 2 to a camera head installing place. In this embodiment, the camera head 2 includes a mount hole 215, which is used for fixation on a tripod, in the housing 21. Here, the camera head installing position means a point where the camera head 2 is arranged and fixed at a position preferable for the subject in a separated state P2 that the camera head 2 is separated from the CCU 4.

Each CCU fixing-screw hole 421 is provided in a side surface where is a bottom surface in this case, of the front block 42 on the same side as the side where each camera head fixing-screw hole 214 is opened in the state that the camera head-side connector 5 is inserted in the CCU-side connector 6. These CCU fixing-screw holes 421 are prepared together with each CCU fixing-screw hole 411 that is provided in the base panel 41 in order to solely fix the CCU 4 at a CCU installing position. Here, the CCU installing place means a point where the CCU 4 is fixed in the separated state P2 that the CCU 4 is separated from the camera head 2.

The camera 1 configured as above can be utilized in the two states, i.e., the combined state P1 that the camera head 2 and the CCU 4 are integrated by inserting the camera head-side connector 5 into the CCU-side connector 6 as shown in FIGS. 1 and 3 and the separated state P2 that the camera head 2 and the CCU unit 4 are separately arranged by connecting the camera head-side connector 5 with the CCU-side connector 6 through the cable 8 as shown in FIG. 4.

Furthermore, the camera head-side connector 5 provided to the camera head 2 is a male type terminal that protrudes beyond the outer shape of the camera head 2 as shown in FIGS. 1, 2, and 4, and the CCU-side connector 6 provided to the CCU 4 is a female type terminal that is concave beyond the outer shape of the CCU 4. Since the camera head-side connector 5 provided to the camera head 2 is of the male type, the outer shape of the camera head 2 excluding the camera head-side connector 5 can be downsized.

Therefore, even if there is no sufficient space where the camera, which is integrally formed from the optical unit to the CCU, is installed, the camera head 2 of the camera 1 is separated from the CCU 4, and the camera head 2 is readily arranged at a location suitable for imaging the subject. Moreover, since the camera head-side connector 5 is protruded to reduce the size of the camera head 2 as much as possible, it is widen an area where the camera head 2 is installed. Additionally, since the CCU-side connector 6 of the CCU 4 is the female type terminal, the camera head 2 is directly connected to the CCU 4. That is, this camera 1 is used just like an integral type camera when the camera 1 is used in the combined state P1. Further, as shown in FIGS. 1 and 3, since the camera head 2 is in contact with the CCU 4 in the combined state P1, the camera head 2 is stable without rattling.

In the separated state P2, as shown in FIG. 4, a cable 8 having a female type terminal 81 on one end and a male type terminal 82 on the other end is adopted for the cable connecting the camera head-side connector 5 to the CCU-side connector 6. When a cable 8A having the female type terminals 81 on both ends is utilized, an adapter 83 that converts a shape can be attached between the cable 8A and the CCU-side connector 6.

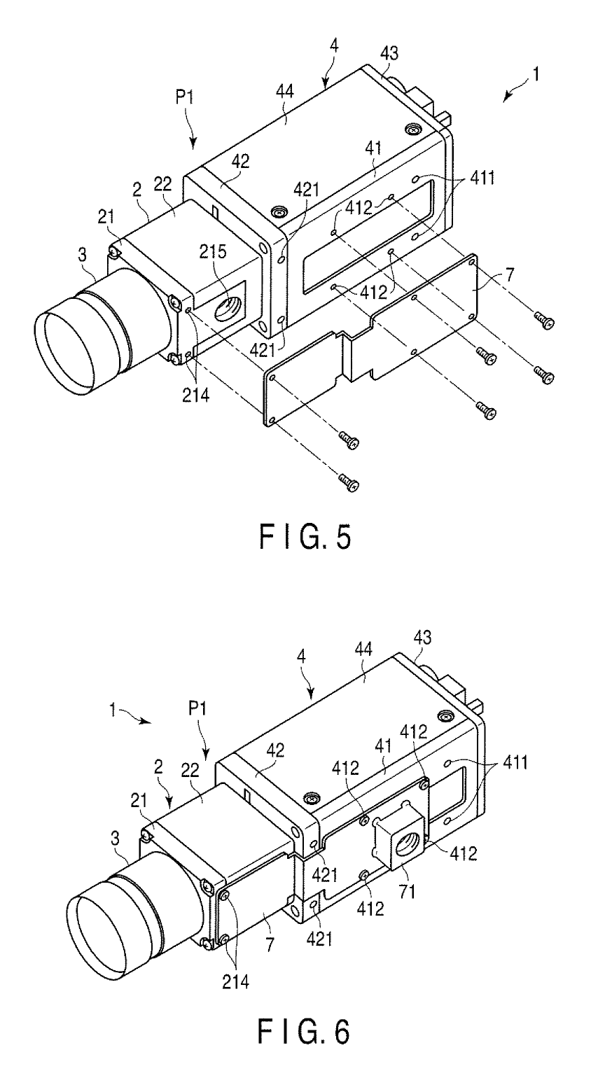

A camera 1 according to a second embodiment of the present invention will now be described with reference to FIG. 5. The camera 1 is different from the camera 1 according to the first embodiment in a position at which a fixing bracket 7 is fixed to a CCU 4, and hence a shape of the fixing bracket 7 is also slightly different. The fixing bracket 7 is fixed by utilizing camera head fixing-screw holes 214 and tripod mount attaching-screw holes 412 in order to connect the camera head 2 with the CCU 4.

Each tripod mount attaching-screw hole 412 is provided in a bottom surface of the base panel 41 which serves as a side surface of the CCU 4 on the same side as the side where each camera head fixing-screw hole 214 is opened in the combined state P1 that the camera head-side connector 5 is inserted in the CCU-side connector 6. The tripod mount attaching-screw holes 412 are prepared for attaching of a tripod mount in order to mount the CCU 4 on the tripod when the CCU 4 is solely placed at a CCU installing location.

Further, this fixing bracket 7 has a narrow section for uncovering the CCU fixing-screw holes 421. Therefore, the camera 1 which is reinforced with the fixing bracket 7 illustrated in FIG. 5 in the combined state P1, is fixed by utilizing the CCU fixing-screw holes 421, when the camera 1 is fixed in a desirable place.

Any other structures of the camera 1 are the same as those in the camera 1 according to the first embodiment, thereby omitting an explanation thereof.

A camera 1 according to a third embodiment of the present invention now will be described with reference to FIG. 6. The camera 1 is different from the camera 1 according to the second embodiment in that a fixing bracket 7 has a tripod mount 71, and any other structures are the same as those in the camera 1 according to the first embodiment and the second embodiment. Same reference numerals denote same parts, thereby omitting an explanation thereof.

Since the camera 1 has the tripod mount 71 on the fixing bracket 7, the camera 1 may be fixed on a tripod or it may be fixed to an additionally prepared bracket by utilizing CCU fixing-screw holes 421 when installing the camera 1 in the combined state P1 depicted in FIG. 6 at a desired position. Furthermore, since the camera 1 is fixed by using the same coupling structure as the fixing structure for the tripod, the camera 1 is easy to fix to an installing place and also easy to remove from the installing place.

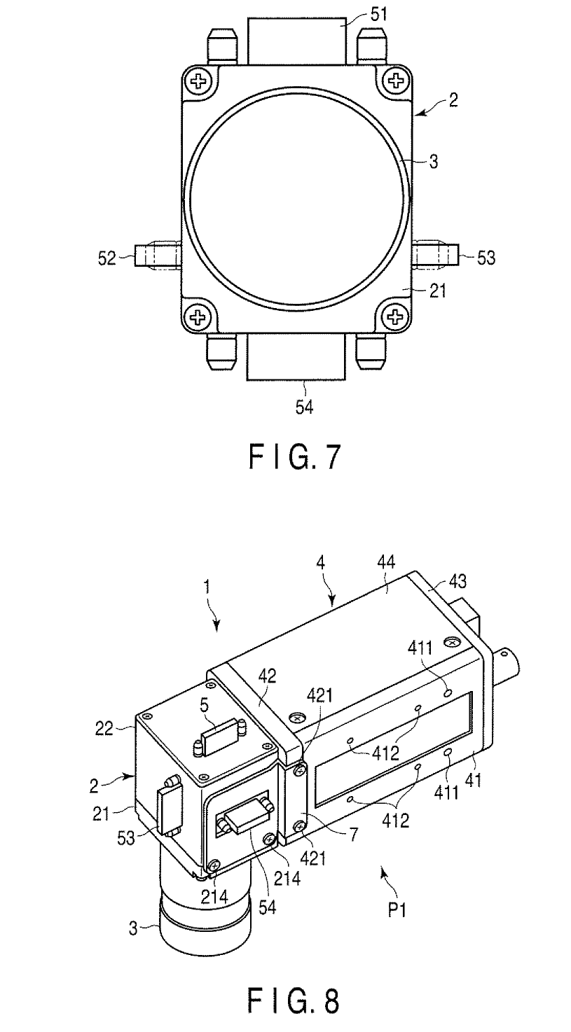

A camera 1 according to a fourth embodiment of the present invention now will be described with reference to FIGS. 7 and 8. A camera head 2 of this camera 1 is different from the camera heads 2 according to the first to third embodiments. This camera head 2 is provided in such a manner that a camera head-side connector 5 protrudes from an outer wall of the camera head 2 in at least one direction crossing an optical axis of a light flux that enters an optical unit 3 from a subject.

Specifically, in addition to the camera head-side connector 5 provided to the camera head 2 of the camera 1 according to the first embodiment, respective camera head-side connectors 51, 52, 53, and 54 are provided in four directions orthogonal to the optical axis of the optical unit 3 as shown in FIG. 7. That is, the camera head 2 having a rectangular parallelepiped shape provides the respective camera head-side connectors 5, 51, 52, 53, and 54 on each wall except a wall on which a lens mount 21 is provided.

In the camera 1 shown in FIG. 8, when a base panel 41 of a CCU 4 is determined as a bottom portion, the corresponding camera head-side connector 52 is inserted into a CCU-side connector 6 of the CCU 4 in a state where the optical unit 3 is set transversely with respect to the CCU 4, thereby the camera head 2 is connected to the CCU 4. the remaining camera head-side connectors 5, 51, 53, and 54 except the camera head-side connector 52 are attached caps that can block magnetism to prevent from picking noise up.

The camera 1 configured as above can be installed in the combined state P1 that the camera head 2 is connected with the CCU 4 by achieving connection with any one of the camera head-side connectors 51, 52, 53, and 54 provided in directions different from that of the camera head-side connector 5, even if the camera 1 is difficult to install at a desired installing place in the combined state P1 that the camera head 2 is connected with the CCU 4 in series in a direction along the optical axis of the optical unit 3. Furthermore, the female type terminal 81 of the cable 8 may connects to the camera head-side connector 51, 52, 53, or 54 which is selected for readily to connect with the terminal 81 when the camera head 2 connects to the CCU 4 by using the cable 8 in the separated state P2.

It is to be noted that five types of camera heads 2 each having the camera head-side connector 5, 51, 52, 53, or 54 may be prepared and appropriately selected in accordance with a using condition in place of one camera head 2 which is provided all the camera head-side connectors 5, 51, 52, 53, and 54.

Moreover, in all the camera 1 of the first embodiment to the fourth embodiment, the optical unit 3 is easily disassembled from the camera head 2. Therefore, the optical unit 3 can be easily replaced with an optimum one in accordance with a using condition.

The inventions are not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A camera comprising:
a camera head including an imaging element;
an optical unit which projects a subject image onto the imaging element;
a camera control unit including an image processing circuit that processes image information output from the camera head;
a camera head-side connector which is provided to protrude beyond an outer shape of the camera head and outputs the image information; and
a CCU-side connector which is opened in an outer wall of the camera control unit and into which the camera head-side connector is inserted.

2. The camera of claim 1, further comprising
a fixing bracket which fixes the camera head to the camera control unit in a state that the camera head-side connector is inserted in the CCU-side connector.

3. The camera of claim 2, wherein
the camera head has camera head fixing-screw holes which are provided in the outer wall except a part facing the camera control unit in the state that the camera head-side connector is inserted in the CCU-side connector, the camera head fixing-screw holes which are prepared to solely fix the camera head at a camera head installation location,
the camera control unit has CCU fixing-screw holes which are provided in a side wall on the same side as a side that the camera head fixing-screw holes are opened in the state that the camera head-side connector is inserted in the CCU-side connector, the CCU fixing-screw holes which are prepared to solely fix the camera control unit at a CCU installation location, and
the fixing bracket is assembled by utilizing the camera head fixing-screw holes and the CCU fixing-screw holes.

4. The camera of claim 2, wherein
the camera head has camera head fixing-screw holes which are provided in the outer wall except a part facing the camera control unit in the state that the camera head-side connector is inserted in the CCU-side connector, the camera head fixing-screw holes which are prepared to solely fix the camera head at a camera head installation location,
the camera control unit has tripod mount attaching-screw holes which are provided in a side wall of the same side as a side that the camera head fixing-screw holes are opened in the state that the camera head-side connector is inserted in the CCU-side connector, the tripod mount attaching-screw holes which are prepared to solely fix the camera control unit at a CCU installation location, and
the fixing bracket is assembled by utilizing the camera head fixing-screw holes and the tripod mount attaching-screw holes.

5. The camera of claim 2, wherein
the fixing bracket includes a tripod mount.

6. The camera of claim 1, wherein
the camera head-side connector protrudes from the outer wall of the camera head in at least one direction crossing an optical axis along which light enters the optical unit from the subject.

7. The camera of claim 1, wherein
the camera head and the camera control unit are connected with each other through a cable between the camera head-side connector and the CCU-side connector.

8. The camera of claim 1, wherein
the camera head-side connector is a male type terminal, and
the CCU-side connector is a female type terminal associated with the male type terminal.

9. The camera of claim 1, wherein
the outer wall of the camera head contacts with the outer wall of the camera control unit in a state that the camera head-side connector is inserted in the CCU-side connector.
